(19) United States
(12) Patent Application Publication
(10) Pub. No.: US 2004/0098741 A1
(43) Pub. Date: May 20, 2004

(54) Method and system for providing an active display while a new channel is being acquired

(76) Inventor: Hiroshi Hara, San Diego, CA (US)

Correspondence Address: STEVEN L. NICHOLS, RADER, FISHMAN & GRAVER PLLC, 10653 S. RIVER FRONT PARKWAY, SUITE 150, SOUTH JORDAN, UT, 84095, US

(21) Appl. No.: 10/295,136

(22) Filed: Nov. 15, 2002

(51) Int. Cl. H04N 5/445; H04N 7/16

(52) U.S. Cl. 725/37; 725/151

(57) ABSTRACT

A set-top box or television set provides an active display while a new channel is being acquired. The set-top box or television set preferably includes a tuner for tuning a selected channel from an incoming signal, a memory for storing material for display while a new channel is being acquired, and a processor for controlling the tuner and for retrieving and outputting the material from the memory while a new channel is being acquired.

### TECHNICAL FIELD

The present invention relates to the field of television broadcasting and the equipment used by viewers to receive television broadcasts. More specifically, the present invention relates to operation of a set-top box or television set during the time required to tune a new channel.

### BACKGROUND

Television is an important means of providing entertainment and information to a wide audience of people. Television signals can be received over-the-air through conventional, terrestrial broadcasts or through proprietary systems.

Proprietary television systems, including cable and satellite systems, have become very popular. Such systems allow a subscriber to receive dozens or even hundreds of television channels, typically with very high picture quality. Proprietary television systems may include both analog and digital channels to provide subscribers with a wide range of entertainment options. Propriety television systems may also provide other services such as pay-per-view events, video-on-demand and electronic programming guides.

Typically, a subscriber to a proprietary television system uses a set-top box or terminal. The set-top box is a box of electronics that receives the television signal from the proprietary system subscribed and processes that signal for use by the subscriber's television set. The set-top terminal is thus connected between the subscriber's television set or video monitor and the proprietary television system.

When watching the programming from a proprietary television system, the user will periodically desire to change the channel being watched. When the user signals for a change of channel, the new or next channel must be acquired by the set-top box from among the various channel signals provided by the proprietary system.

The acquisition or tuning of the new channel typically requires a noticeable period of time to accomplish. Depending on the system and the system conditions at that time, acquiring a new channel may take several seconds or more.

In conventional systems, the television set is blanked during the time required to tune a new channel. In other words, the subscriber's screen goes blank or dark while the new channel is acquired. This may be both boring and annoying to the subscriber who sits watching an inactive display while the desired channel is being acquired.

### SUMMARY

In one of many possible embodiments, the present invention provides a set-top box for providing an active display while a new channel is being acquired. The set-top box preferably includes a tuner for tuning a selected channel from an incoming signal, a memory for storing material for display while a new channel is being acquired, and a processor for controlling the tuner and for retrieving and outputting the material from the memory while a new channel is being acquired.

In another embodiment, a television set is configured to provide an active display while a new channel is being acquired. The television set preferably includes a display, a tuner for tuning a selected channel from an incoming signal, a memory for storing material for display on said display while a new channel is being acquired and a processor for controlling said tuner and for retrieving and outputting said material from said memory while a new channel is being acquired.

Another embodiment provides a method of providing an active display while a new channel is being acquired by transmitting material from a memory unit of a set-top box or television set for display during a period of time in which the set-top box or television set is acquiring a new channel.

Another embodiment provides a method of advertising by storing advertising material in a memory unit of a set-top box or television set, and transmitting the advertising material from the memory unit for display during a period of time in which the set-top box or television set is acquiring a new channel.

Another embodiment provides a method of providing an active display while a new channel is being acquired by loading user-selected material into a memory unit of a set-top box or television set and transmitting the user-selected material from the memory unit for display during a period of time in which the set-top box or television set is acquiring a new channel.

### BRIEF DESCRIPTION OF THE DRAWINGS

The accompanying drawings illustrate various embodiments of the present invention and are a part of the specification. Together with the following description, the drawings demonstrate and explain the principles of the present invention. The illustrated embodiments are examples of the present invention and do not limit the scope of the invention.

FIG. 1 illustrates a set-top terminal and related equipment for providing a subscriber with access to a proprietary television signal.

FIG. 2 illustrates the operation of various components of the system illustrated in FIG. 1 to explain the source of the delay when acquiring or tuning a new channel.

FIG. 3 illustrates the operation of various components of a system according to an embodiment of the present invention in which the time during which a new channel is being acquired is used to display stored material.

FIG. 4a illustrates a system including a set-top box according to an embodiment of the present invention for accessing a proprietary television system and providing a display of material during the time in which a new channel is being tuned.

FIG. 4b illustrates a television set according to another embodiment of the present invention that stores and displays material during periods when the display would otherwise be inactive.

FIG. 5 is a flowchart illustrating a method of operating the system illustrated in FIGS. 4a and 4b according to embodiments of the present invention.

Throughout the drawings, identical reference numbers designate similar, but not necessarily identical, elements.

### DETAILED DESCRIPTION OF EMBODIMENTS

Material that is received and stored in a memory unit of a television set or a set-top terminal can be retrieved and displayed to provide an active display during periods of time when, for example, a newly selected channel is being acquired. Various embodiments of such a system can be implemented for both subscribers to proprietary television systems and viewers of television signal broadcasts that may not be carried on a proprietary system.

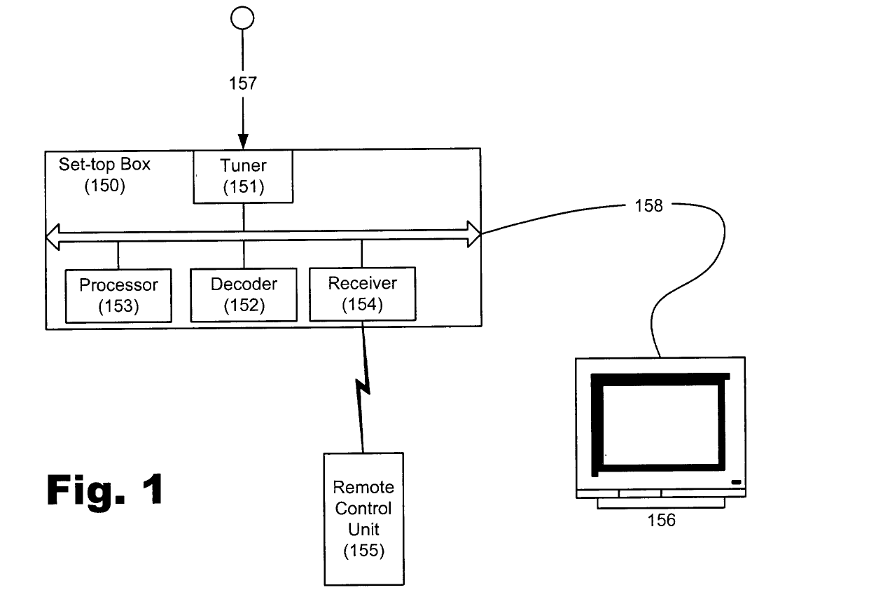

FIG. 1 illustrates a set-top terminal and related equipment for providing a viewer with access to a proprietary television signal. As used herein, and in the attached claims, a “proprietary television system” is a system, such as a cable or satellite system, for which a viewer uses a set-top terminal to access the television programming and other services of the system.

As shown in FIG. 1, a set-top box or terminal (150) is connected to a proprietary television system (157) and receives a proprietary television signal from the system (157). The signal may carry dozens or even hundreds of channels of television programming. This signal is received by a tuner (151) in the set-top box (150). The tuner (151), under control of the central processor (153) of the set-top box (150), will tune a desired channel from among the many channels included in the signal from the proprietary system (157). The signal for the tuned channel is then output by the tuner (151).

If the tuned channel is a digital channel, the set-top box (150) will also have to decode the channel signal. A decoder (152) in the set-top box (150) performs the decoding.

The tuned and, if necessary, decoded channel signal is then output from the set-top terminal (150) over a connection (158) to a subscriber's television set or video monitor (156). The monitor (156) can then display the channel that the subscriber wishes to see. As used herein, and in the appended claims, the term “acquire” will be used to describe the complete process of tuning and, if necessary, decoding a new channel signal.

A remote control unit (155) is also preferably used to signal the set-top box (150) to, for example, channel the channel being tuned. The remote control unit (155) preferably sends a wireless signal, such as an infrared signal, to a receiver (154) in the set-top box (150). The receiver (154) receives the signal from the remote control unit (155) and provides the data from the remote control unit (155) to the central processor (153).

The signal from the remote control unit (155) may, for example, direct the set-top terminal to switch to the next channel, either up or down, in the numeric listing of available channels. Alternatively, the signal from the remote control unit (155) may specify by number a channel that is to be tuned from among the available channels.

In either event, the receiver (154) conveys the command to the processor (153). The processor (153) then controls the tuner (151) accordingly.

Under control of the processor (153), the tuner (151) will tune the channel desired by the user and will begin outputting the signal for that channel. If the channel is digital, the signal for the tuned channel will be decoded by the decoder (152). The channel signal is then output by the set-top box (150) to the user's television or video monitor (156).

When the tuner (151) tunes a new channel, it requires some period of time for the new channel to be tuned or acquired. Additionally, if the new channel is digital and has to be decoded by the decoder (152), it requires some additional time for the decoding to occur before the signal for the new channel is provided over the connection (158) to the television or monitor (156).

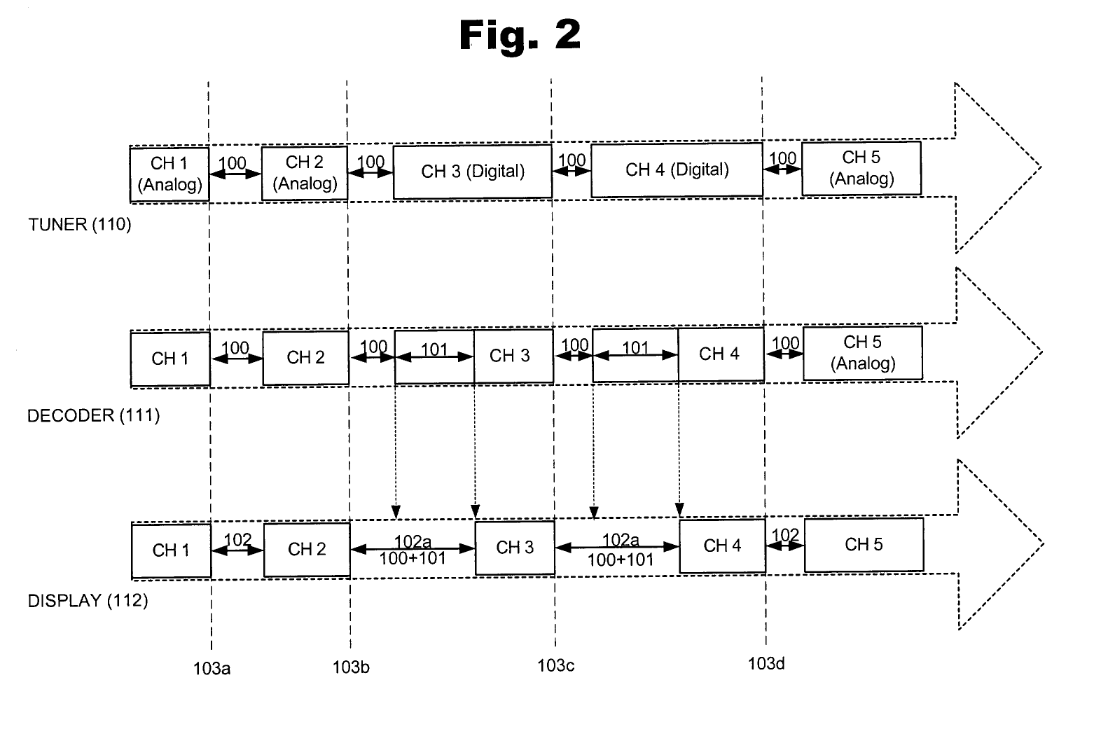

FIG. 2 illustrates the operation of various components of the system illustrated in FIG. 1 to explain the source of the delay when acquiring or tuning a new channel. FIG. 2 includes three arrows, the first (110) indicates operation of the tuner (151, FIG. 1), the second (111) indicates the operation of the decoder (152, FIG. 1) and the third indicates operation of the display as seen on the video monitor (156, FIG. 1a) connected to the set-top box. The arrows are provided to illustrate the operation of each indicated component as a function of time, with time increasing to the left.

Vertical lines (103) indicate points in time at which a viewer signals for a change of the channel being shown. For simplicity of explanation, in the example of FIG. 2, the viewer is moving sequentially through the channels, from channel 1 to channel 5. However, it will be understood that the same principles would apply if the user were jumping between non-sequential channels by indicating the number of each channel desired.

As shown in FIG. 2, the set-top box is initially tuned to channel 1 (CH1) as shown in arrow (110). In this example, channel 1 is an analog channel. Consequently, channel 1 is not decoded, but is displayed on the viewer's display, as shown in arrow (112). 100341 Subsequently, at line (103a), the viewer signals, preferably with the remote control unit (155, FIG. 1), that channel 2 (CH2) should be tuned. The tuner, as shown in arrow (110), then tunes to channel 2. A period of time (100) is required for the tuner to tune a new channel, i.e., channel 2.

After the time (100) required to tune channel 2, the signal for channel 2 is output by the tuner. Channel 2, in this example, is an analog channel, so no further delay is introduced at the decoder, as shown in arrow (111). The signal for channel 2 is then delivered to the viewer's television or monitor and appears, after the delay (100), on the display, as shown in arrow (112). The delay (100) is seen on the display (112) as an inactive period (102) in which the display is blank or dark.

Next, at line (103b), the viewer again signals for the set-top box to tune channel 3. Again, the tuner, as shown in arrow (110), takes a period of time (100) to tune the new channel, i.e., channel 3. The signal for channel 3 is then output by the tuner.

In this example, channel 3 is a digital channel. Consequently, the signal for channel 3 is taken by the decoder (152; FIG. 1) and decoded. As shown in arrow (111), this introduces a second delay (101) before the decoder outputs the signal for channel 3 to the viewer's television.

Consequently, on the display, as shown in arrow (112), there is an extended delay (102a) before display of channel 3 begins. This extended delay (102a) includes the delay (100) to tune the new channel and the delay (101) introduced by decoding of the channel. As before, this extended delay (102a) is seen on the display (112) as an inactive period (102) in which the display is blank or dark.

As further indicated in FIG. 2, whenever a new digital channel is tuned, e.g., channel 4 (CH4), there is a delay (100) caused by the tuner tuning the new channel and a second delay (101) caused by the decoder decoding the channel. The result is an extended delay (102a) on the viewer's display before the new channel can be viewed.

Whenever a new analog channel is tuned, e.g., channel 5 (CH5), there is the delay (100) caused by the tuner tuning the new channel, but no delay for decoding. Consequently, an inactive period (102) results on the viewer's display before channel 5 can be watched.

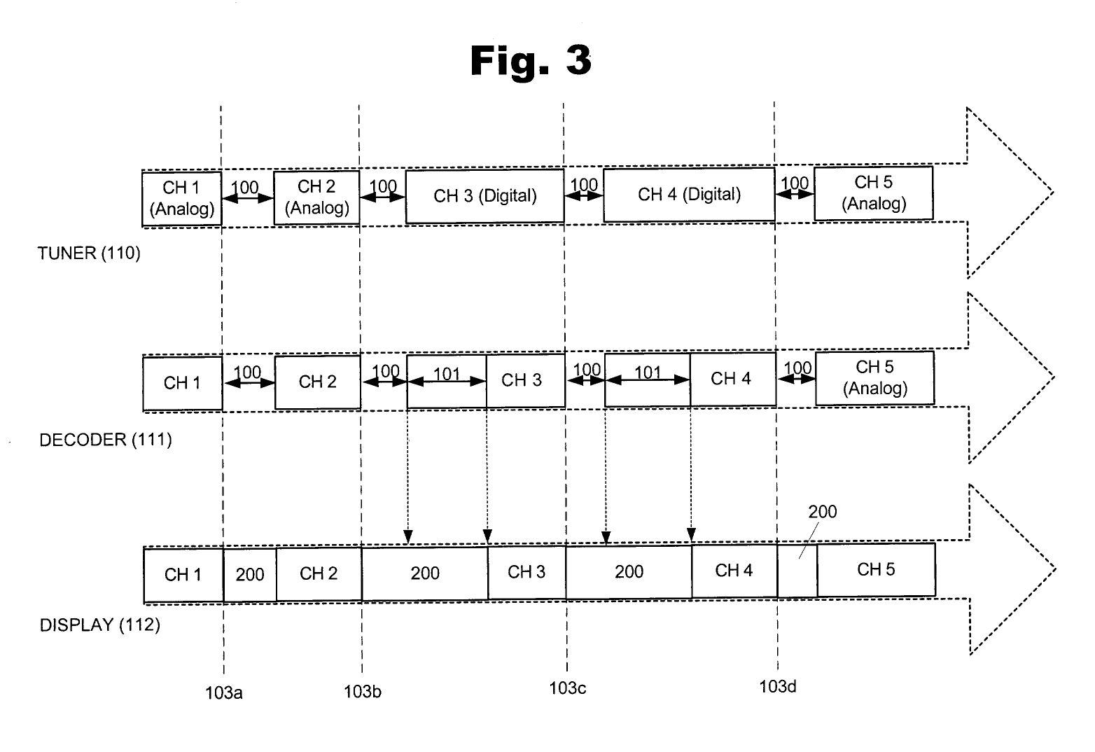

FIG. 3 illustrates the operation of various components of a system receiving a television signal in which the time during which a new channel is being tuned is used to display material according to an embodiment of the present invention. Within FIG. 3, the operation of the tuner and the decoder, as seen in arrows (110) and (111) respectively, is very similar to that illustrated and explained in connection with FIG. 2 above. The tuner and decoder described with regard to FIG. 3 may be incorporated into a set-top terminal or directly into a television set.

As shown in FIG. 3, the operation of the display, i.e., the viewer's television or monitor, is improved as shown in arrow (112). According to this embodiment of the present invention, material (200) is shown on the viewer's display (112) between viewing the previously tuned channel (e.g., CH1) and new channel being acquired (e.g., CH2). This material (200) can expand or decrease in length to fill the time available between tuning of the previous channel and the new channel. Thus, if the delay is longer because a digital channel is being acquired and decoding is needed, the material (200) still fills the time until the next channel is successfully tuned. Consequently, the viewer has something to view during those periods of delay in which the viewer's display was previously inactive (e.g., 102, 102a, FIG. 2).

The material (200) can be anything that the television broadcasting company, proprietary system operator or the viewer wish to display. The material (200) can be any still graphic or appropriately short motion picture sequence or clip. For example. The material (200) may be an advertisement. Depending on the time available, this advertisement may simply be a still shot, similar to a printed ad, or may be a short, motion picture commercial. The material (200) may be a logo representing the new channel that is being tuned. Alternatively, the material (200) may be information about the program being shown on the new channel being tuned. This information may include title, synopsis, rating information, running time remaining, etc. This information may be taken from an electronic programming guide provided by the proprietary television system.

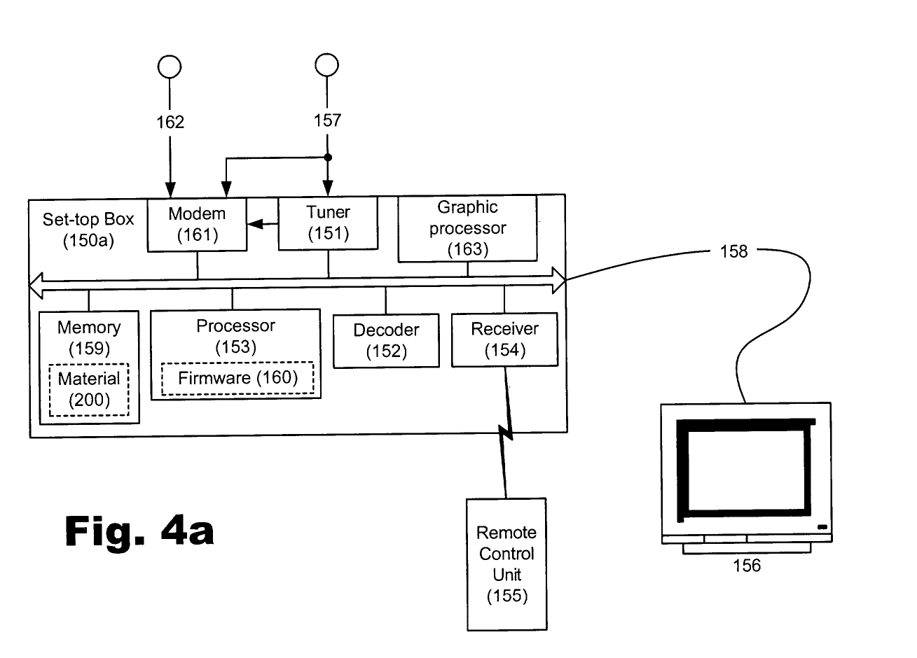

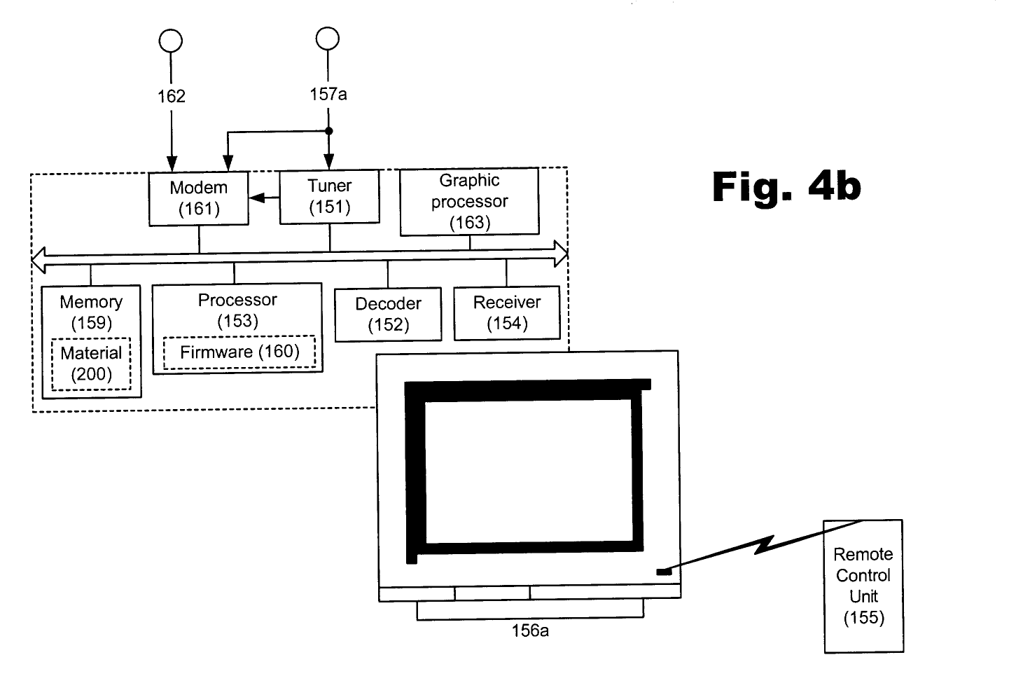

FIG. 4a illustrates a system according to a first embodiment of the present invention for accessing a proprietary television system and providing a display of material during the time in which a new channel is being tuned. As shown in FIG. 4a, a set-top box (150a) preferably includes a memory unit (159). The memory unit (159) is used to store the material (200) that will be displayed by the system during the blank intervals when a new channel is being tuned and, possibly, decoded.

The central processor (153) will be programmed with firmware (160) specific to embodiments of the present invention. When executing the firmware (160), the processor (153) will receive commands from the user to periodically change the channel tuned. As described above, these commands will preferably come from the remote control unit (155) through the receiver (154). However, such commands could also come from a user input device, such as a series of buttons or a keypad, integrated into the set-top box (150a).

Upon receipt of a command to tune a new channel, the processor (153), executing the firmware (160), will control the tuner (151) to tune the desired channel. The processor (153) will also retrieve material from the memory (159) that can be displayed during the period of time that the new channel is being tuned and, in some cases, decoded. This material is submitted to a graphic processor (163) which outputs the material for display to the television set or monitor (156) connected (158) to the set-top box (150a).

The interstitial material (200) that is stored in the memory (159) can come from a wide variety of sources. For example, the set-top box (150a) may include a cable modem (161) that is connected to the proprietary system (157). In such a case, the cable modem (161) may extract a data stream from the proprietary television signal. This extracted data stream may then be cached as the material (200) in the memory (159).

As indicated, the data stream may include an electronic program guide with information about the programming being shown or scheduled on the channels of the system. The data stream may also include advertising, still or motion picture, that is periodically changed based on advertising fees paid. This data may be provided in the signal of the currently tuned channel using the Advanced Television Enhancement Forum (ATVEF). This data is cached as part of the material (200) in the memory (159) and then retrieved and displayed during otherwise blank periods when the set-top box (150a) is tuning and, perhaps, decoding a new channel signal.

Alternatively, the modem (161) is not necessarily a cable modem, but may be a modem connected to another data source (162). This other data source (162) may be, for example, the Internet, a dial-up network, a local area network, a wide area network, a personal computer, an optical or floppy disc drive, etc. The modem (161) can download material (200) from the data source (162) for storage in the memory (159). The firmware (160) may include a browser or other functions for navigating and downloading data from the data source (162). In such a case, the remote control unit (155) and monitor (156) can be used as part of the user interface to control the downloading of data to the memory (159).

In this way, a user can input material (200) to the set-top box (150a) that he or she wishes to have displayed during blank periods when the set-top box (150a) is tuning and, in some cases, decoding a new channel signal. In such a case, the material (200) may be any still graphic or motion picture clip, for example, pictures of friends or family, scenic pictures, photographs taken by the user, animated sequences, etc.

As noted above, the idea of providing an active display during otherwise inactive periods, such as acquiring a new channel, can be applied to both proprietary and non-proprietary television broadcasting. The embodiment described above includes a set-top terminal and is suited to use with a proprietary television system. But, while a proprietary television system was described above, embodiments of the present invention can also be applied to “non-proprietary television systems” or “public television systems” such as NTSC/ATSC Analog/Digital Terrestrial Television Systems. In such embodiments, there may be no set-top box. Rather, the tuner, memory, processor, etc., and the functions of the set-top box described herein may be incorporated directly into a television set.

FIG. 4b illustrates an alternative embodiment in which various components discussed above are incorporated into a television set (156a). As shown in FIG. 4b, the television set (156a) includes a tuner (151) that receives a television signal. This television signal can come form a proprietary or non-proprietary system (157a). For example, the television signal can come from a traditional terrestrial broadcasting company or a cable or satellite company.

The television set (157a) also includes a memory (159) and programmed processor (153), as described above. The memory (159) is used to store material (200) that is displayed when the television set display would otherwise be inactive, such as when a newly selected channel is being tuned or decoded. As above, the material (200) can be extracted from an incoming television signal or obtained from some other source (e.g., 162). A redundant explanation of the other components in FIG. 4b will be omitted.

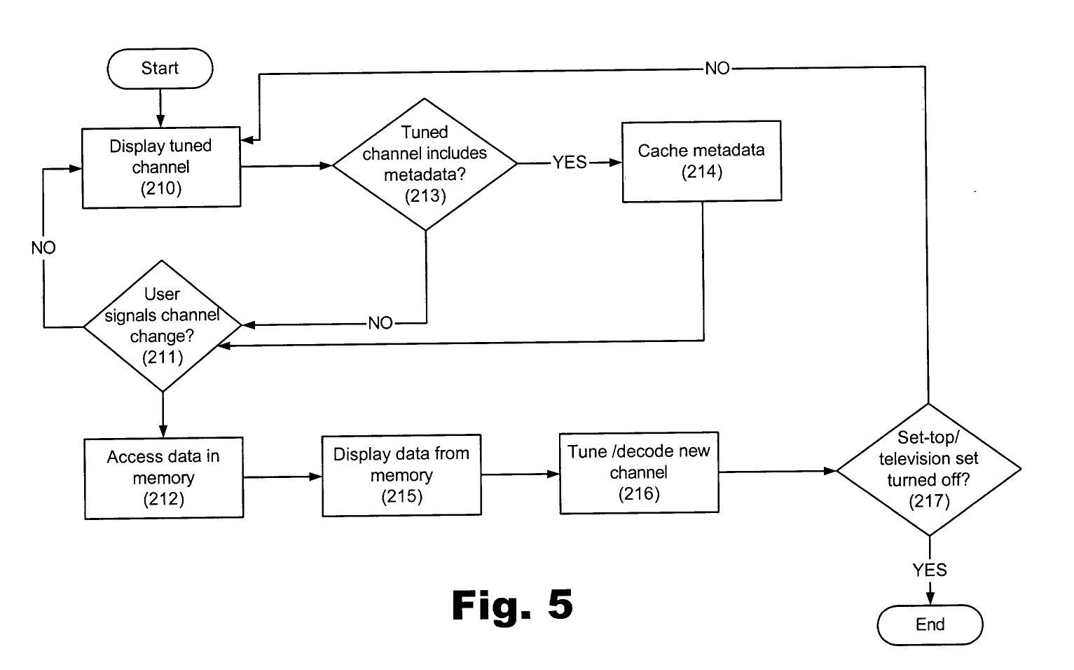

FIG. 5 is a flowchart illustrating a method of operating the systems illustrated in FIGS. 4a and 4b according to embodiments of the present invention. As shown in FIG. 5, a tuned channel is displayed on a television set or on the monitor connected to a set-top box. (Step 210). The tuned channel may be providing additional data that can be cached for display during the period when a new channel is being acquired. (Determination 213). This additional data may be referred to as metadata and may provide, for example, advertising or programming information, as described above. The data may be cached in a set-top box memory or a memory incorporated into a television set.

If metadata is being provided in the currently tuned channel signal, that data can be cached in the memory of the set-top box or television set for later display during the period when a new channel is being acquired. (Step 214). As described above, data may also be downloaded from other data sources and stored in the memory of the set-top box or television set for later use during the period when a new channel is being acquired.

When the viewer signals for a change of channel (Determination 211), the set-top box or television set will access data from its memory that has been download and stored or cached from and incoming television signal. (Step 212). The data retrieved from memory is then displayed on the television or the monitor connected to the set-top box. (Step 215). While the data is being displayed, the new channel indicated by the viewer is tuned and, if necessary, decoded. (Step 216).

When the new channel signal is acquired, the display of the material from memory is discontinued and the acquired channel is displayed. Consequently, the viewer does not experience a period in which the television or monitor is blank and has nothing to display.

This method repeats until the set-top box or television set is turned off. (Determination 217). When the set-top box or television set is deactivated, the method terminates.

The preceding description has been presented only to illustrate and describe embodiments of invention. It is not intended to be exhaustive or to limit the invention to any precise form disclosed. Many modifications and variations are possible in light of the above teaching.

The foregoing embodiments were chosen and described in order to illustrate principles of the invention and some practical applications. The preceding description enables others skilled in the art to utilize the invention in various embodiments and with various modifications as are suited to the particular use contemplated. It is intended that the scope of the invention be defined by the following claims.

What is claimed is:

1. A set-top box for providing an active display while a new channel is being acquired comprising:
a tuner for tuning a selected channel from an incoming signal;
a memory for storing material for display while a new channel is being acquired; and
a processor for controlling said tuner and for retrieving and outputting said material from said memory while a new channel is being acquired.

2. The set-top box of claim 1, further comprising a cable modem for extracting data from said incoming signal that is cached in said memory as said material.

3. The set-top box of claim 1, further comprising a modem connected to a data source for receiving data that is then stored in said memory as said material.

4. The set-top box of claim 1, wherein said data source comprises the Internet.

5. The set-top box of claim 1, wherein said material is an advertisement.

6. The set-top box of claim 1, wherein said material is information about a program being broadcast on said new channel.

7. The set-top box of claim 6, wherein said information is extracted from an electronic programming guide.

8. The set-top box of claim 1, further comprising a user interface.

9. The set-top box of claim 8, wherein said user interface comprises a remote control unit.

10. The set-top box of claim 8, wherein said user interface allows a user to control downloading of data to said memory which is stored as said material, said material being user-selected.

11. The set-top box of claim 1, further comprising a decoder for decoding digital channels.

12. A method of providing an active display while a new channel is being acquired, said method comprising transmitting material from a memory unit of a set-top box or a television set for display on said television set during a period of time in which said set-top box or television set is acquiring a new channel.

13. The method of claim 12, further comprising:
extracting a data stream from an incoming television signal; and
caching said data stream in said memory unit as said material.

14. The method of claim 12, further comprising:
downloading data from a data source; and
storing said data in said memory unit as said material.

15. The method of claim 14, further comprising allowing a user to control said downloading and select data for download with a user interface.

16. The method of claim 12, further comprising displaying said material on said television set during said period of time in which said set-top box or television set is acquiring a new channel.

17. The method of claim 16, wherein said material comprises advertising.

18. The method of claim 16, wherein said material comprises information about a program broadcast on said new channel.

19. The method of claim 16, further comprising acquiring said new channel with said set-top box.

20. The method of claim 19, wherein said acquiring said new channel comprises tuning and decoding a signal for said new channel.

21. A method of advertising, said method comprising:
storing advertising material in a memory unit in a set-top box or a television set; and
transmitting said advertising material from said memory unit for display on said television set during a period of time in which said set-top box or said television set is acquiring a new channel.

22. The method of claim 21, further comprising acquiring said new channel.

23. The method of claim 22, wherein said acquiring said new channel comprises tuning and decoding a signal for said new channel.

24. A method of providing an active display while a new channel is being acquired, said method comprising:
loading user-selected material into a memory unit of a set-top box or a television set; and
transmitting said user-selected material from said memory unit for display on the television set during a period of time in which said set-top box or television set is acquiring a new channel.

25. The method of claim 24, further comprising:
downloading data from a data source; and
storing said data in said memory unit as said user-selected material.

26. The method of claim 25, further comprising allowing a user to control said downloading and select data for download with a user interface.

27. A system for providing an active display while a new channel is being acquired, said system comprising:
storage means for storing audiovisual material; and
processing means for retrieving and transmitting said material from said storage means for display on a display means during a period of time in which a new channel is being acquired.

28. The system of claim 27, further comprising:
means for extracting a data stream from an incoming television signal; and
means for caching said data stream in said storage means as said material.

29. The system of claim 27, further comprising:
means for downloading data from a data source; and
means for storing said data in said storage means as said material.

30. The system of claim 29, further comprising user interface means for allowing a user to control said means for downloading and to select data for download.

31. The system of claim 27, wherein said material comprises advertising.

32. The system of claim 27, wherein said material comprises information about a program broadcast on said new channel.

33. A television set configured to provide an active display while a new channel is being acquired comprising:
a display;
a tuner for tuning a selected channel from an incoming signal;
a memory for storing material for display on said display while a new channel is being acquired; and
a processor for controlling said tuner and for retrieving and outputting said material from said memory while a new channel is being acquired.

34. The television set of claim 33, further comprising a cable modem for extracting data from said incoming signal that is cached in said memory as said material.

35. The television set of claim 33, further comprising a modem connected to a data source for receiving data that is then stored in said memory as said material.

36. The television set of claim 33, wherein said data source comprises the Internet.

37. The television set of claim 33, wherein said material is an advertisement.

38. The television set of claim 33, wherein said material is information about a program being broadcast on said new channel.

39. The set-top box of claim 6, wherein said information is extracted from an electronic programming guide.

40. The television set of claim 33, further comprising a user interface.

41. The television set of claim 40, wherein said user interface comprises a remote control unit.

42. The television set of claim 40, wherein said user interface allows a user to control downloading of data to said memory which is stored as said material, said material being user-selected.

43. The television set of claim 33, further comprising a decoder for decoding digital channels.
